(19) United States
(12) Patent Application Publication
(10) Pub. No.: US 2015/0334464 A1
(43) Pub. Date: Nov. 19, 2015

(54) DISPLAY APPARATUS AND CONTROL METHOD OF THE SAME

(71) Applicant: SAMSUNG ELECTRONICS CO., LTD., Suwon-si (KR)

(72) Inventor: Ki-hoon SHIN, Yongin-si (KR)

(73) Assignee: SAMSUNG ELECTRONICS CO., LTD., Suwon-si (KR)

(21) Appl. No.: 14/711,216

(22) Filed: May 13, 2015

(30) Foreign Application Priority Data
May 13, 2014 (KR) 10-2014-0057083

(51) Int. Cl. H04N 21/482; H04N 21/45; H04N 21/485; G06F 3/16; G06F 3/0481; G06F 3/0482; G06F 3/0484; G06F 3/01; H04N 21/431; H04N 21/4722

(52) U.S. Cl. CPC H04N 21/4821; H04N 21/4314; H04N 21/4532; H04N 21/4826; H04N 21/4858; H04N 21/4722; G06F 3/04817; G06F 3/0482; G06F 3/04842; G06F 3/04845; G06F 3/017; G06F 3/167

(57) ABSTRACT

A display apparatus and a control method thereof are provided. The display apparatus includes: a receiver configured to receive a broadcasting content corresponding to one channel among a plurality of channels; a display configured to display an image of the received broadcasting content; a user input configured to receive a user input; and a controller configured to control the display to display a content map in which an icon of at least one broadcasting content belonging to a corresponding content group is arranged in a region for a plurality of content groups, and display an image of the broadcasting content in response to the icon of the broadcasting content being selected according to the user input.

### CROSS-REFERENCE TO RELATED APPLICATION

This application claims priority from Korean Patent Application No. 10-2014-0057083, filed on May 13, 2014 in the Korean Intellectual Property Office, the disclosure of which is incorporated herein by reference.

### BACKGROUND

1. Field

Apparatuses and methods consistent with exemplary embodiments relate to a display apparatus and a control method of the same, and more particularly to a display apparatus which displays an image of a broadcasting content in response to a user input as a plurality of broadcasting contents are arranged in accordance with predetermined groups, and a control method of the same.

2. Description of the Related Art

In a conventional method of searching a broadcasting program in a smart television (TV) or a smart phone, a user has generally used an electronic program guide (EPG) to search programs being broadcasted or to be broadcasted. The existing EPG gives an interface in the form of a table having two axes of a channel and time, in which a vertical axis corresponds to a broadcasting channel, and a horizontal axis corresponds to a broadcasting time, thereby showing a list of programs being broadcasted or to be broadcasted with respect to time. Through the EPG, a viewer operates buttons of a remote controller up and down to search channels, and left and right to select a program being broadcasted or schedule the program to be broadcasted.

However, with the development of various types of cables and Internet, the number of broadcasting channels increases and thus it is not easy for a viewer to search a desired program or content. The existing EPG has a limit to show channels, a broadcasting schedule, etc. through the screen, and it is impossible to view programs currently broadcasted in one screen. Therefore, it is inconvenient for a viewer to operate the buttons of the remote controller continuously until a desired channel is searched. Also, most of channels corresponding to similar contents are not grouped, and thus it takes much time to find the channels broadcasting an interesting content.

Also, while a viewer watches the TV, the viewer may often wonder about the current program being broadcasted rather than the running order of upcoming programs. However, the existing EPG is inconvenient since it is impossible to view contents being currently broadcasted at one view.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

One or more exemplary embodiments provide a display apparatus, which displays a content map in which an icon of at least one broadcasting content is arranged in each region of a plurality of content groups, and displays an image of a broadcasting content if the icon of the at least one broadcasting content is selected while moving the content map in response to a user input, and a control method thereof.

According to an aspect of an exemplary embodiment, there is provided a display apparatus including: a receiver configured to receive a broadcasting content corresponding to one channel among a plurality of channels; a display configured to display an image of the received broadcasting content; a user input configured to receive a user input; and a controller configured to control the display to display a content map in which an icon of at least one broadcasting content that belongs to a corresponding content group is arranged in a region for a plurality of content groups, and display an image of the broadcasting content in response to the icon of the at least one broadcasting content being selected according to the user input.

The controller may be configured to change the region for the displayed content group by moving the content map according to the user input.

The content group may be classified according to at least one of a kind, a genre, a rating, a channel, and broadcasting time of the broadcasting content. The controller may determine the content group to which the broadcasting content belongs according to the user input.

The controller may determine at least one of a position and a size of the region for the content group displayed on the content map based on a user's view history. Also, the controller may change at least one of the position and size of the region for the content group currently being displayed to adjust the position and size of the region for the interesting content group in accordance with a user's preferences.

The user input may include a hand gesture control with regard to the displayed content map.

The controller may control a content view region to be displayed together with the content map, and control a broadcasting content corresponding to a selected icon of a broadcasting content to be displayed in the content view region in response to the icon of the broadcasting content being selected according to the user input.

The user input may include an input of dragging the icon of the broadcasting content into the content view region.

The controller may control the broadcasting content displayed in the content view region to be displayed as a full screen according to a user's hand gesture or a voice command.

Thus, the image of various broadcasting contents can be quickly reproduced through the content view region.

The user input may include a voice command to select the icon of the broadcasting content. The controller may display a title of the broadcasting content in the icon of the broadcasting content, and store the displayed title of the broadcasting content.

According to an aspect of another exemplary embodiment, there is provided a control method of a display apparatus, the method including: receiving a broadcasting content corresponding to one channel among a plurality of channels; displaying a content map in which an icon of at least one broadcasting content belonging to a corresponding content group is arranged in a region for a plurality of content groups; and displaying an image of the broadcasting content in response to the icon of the broadcasting content being selected according to the user input.

The method may further include changing the region for the displayed content group by moving the content map according to the user input.

The content group may be classified according to at least one of a kind, a genre, a rating, a channel, and broadcasting time of the broadcasting content.

The method may further include determining the content group to which the broadcasting content belongs according to the user input.

The method may further include determining at least one of a position and a size of the region for the content group displayed on the content map based on a user's view history.

The method may further include changing at least one of the position and size of the region for the content group currently being displayed.

The user input may include a hand gesture control with regard to the displayed content map.

The method may further include displaying a content view region together with the content map; and displaying a broadcasting content corresponding to a selected icon of a broadcasting content in the content view region in response to the icon of the broadcasting content being selected according to the user input.

The user input may include an input of dragging the icon of the broadcasting content into the content view region.

The method may further include displaying the broadcasting content displayed in the content view region as a full screen according to a user's hand gesture or a voice command.

The user input may include a voice command to select the icon of the broadcasting content.

The method may further include displaying a title of the broadcasting content in the icon of the broadcasting content, and storing the displayed title of the broadcasting content.

According to an aspect of another exemplary embodiment, there is provided a control method of an image processing apparatus, the method including: controlling to display a content map in which an icon of at least one broadcasting content belonging to a corresponding content group is arranged in a region for a plurality of content group; and controlling to change the region for the plurality of content group by moving the content map according to the user input, and to display an image of the broadcasting content in response to the icon of the broadcasting content being selected according to the user input.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display apparatus according to an exemplary embodiment;

FIG. 2 shows an example of a content map in which an icon of at least one broadcasting content is arranged in each region of a plurality of content group according to an exemplary embodiment;

FIG. 3 shows an example of setting up the plurality of content groups, to which the broadcasting content belongs, in response to a user's input according to an exemplary embodiment;

FIG. 4 shows an example of determining and displaying at least one of a position and size of region for the content group in accordance with a user's view history according to an exemplary embodiment;

FIG. 5 shows an example of changing at least one of the position and size of region for the content group displayed on the content map according to an exemplary embodiment;

FIG. 6 shows an example of moving the content map so that the region for displaying the content group is changed according to an exemplary embodiment;

FIG. 7 shows an example in which the region for the content group selected on the content map is zoomed in and displayed as a full screen;

FIG. 8 shows an example of displaying an image through a content view region displayed together with the content map according to an exemplary embodiment;

FIG. 9 is a block diagram of the display apparatus connected to an external device according to an exemplary embodiment; and

FIG. 10 is a flowchart showing a control method of the display apparatus according to an exemplary embodiment.

### DETAILED DESCRIPTION OF EXEMPLARY EMBODIMENTS

Hereinafter, exemplary embodiments will be described in detail with reference to accompanying drawings so as to be easily realized by a person having an ordinary skill in the art, but not limited to the following embodiments set forth herein. Descriptions about unrelated parts are omitted for clarity, and like numbers refer to like elements throughout.

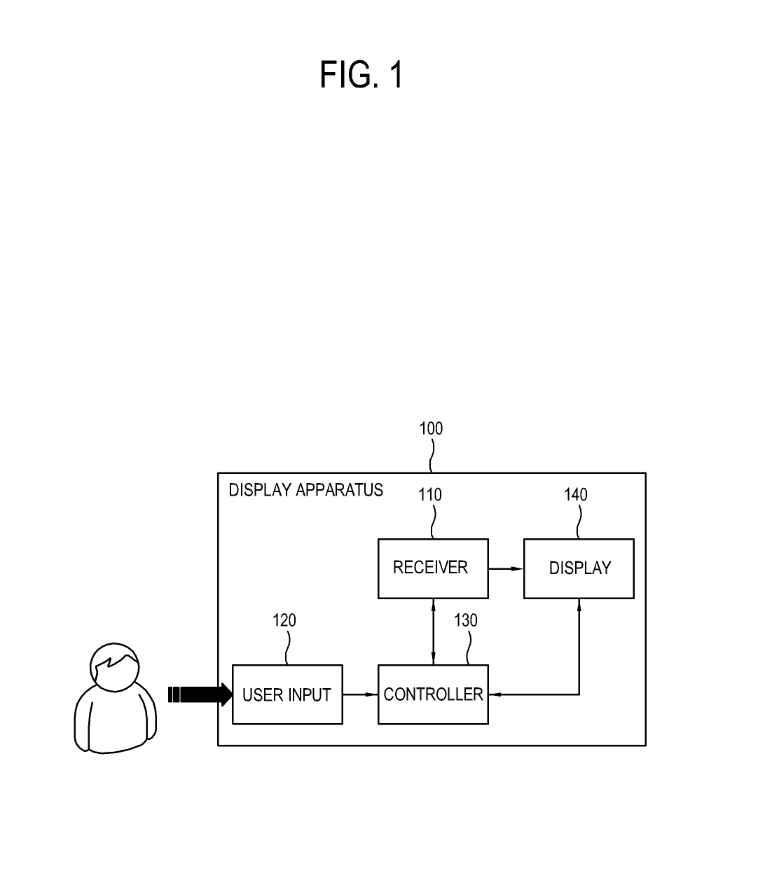

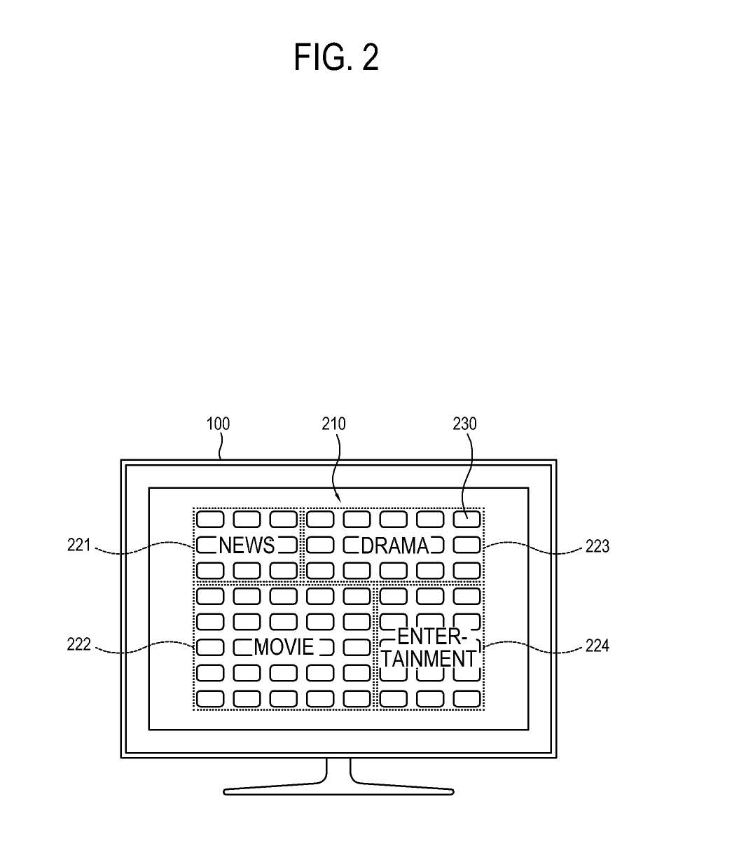

FIG. 1 is a block diagram of a display apparatus according to an exemplary embodiment. As shown in FIG. 1, the display apparatus 100 includes a receiver 110, a user input 120, a controller 130, and a display 140. For example, the display apparatus 100 may include a smart TV, a smart phone, a tablet computer, etc. As shown in FIG. 2, the display apparatus 100 receives a broadcasting content corresponding to one channel among a plurality of channels, and displays a content map 210 in which an icon 230 of at least one broadcasting content belonging to a content group is arranged in each corresponding region 221, 222, 223, and 224 for the plurality of content groups. The display apparatus 100 changes the regions 221, 222, 223 and 224 for displaying the content groups by moving the content map 210 in response to a user input. The display apparatus 100 displays an image of the broadcasting content if the icon 230 of the broadcasting content is selected in response to the user input. Thus, while searching a broadcasting content, the display apparatus 100 according to an exemplary embodiment displays the content map in which the icon of at least one broadcasting content is arranged in each region for the plurality of content groups, and displays an image of the broadcasting content if the icon of the broadcasting content is selected by moving the content map according to a user input, thereby allowing a user to more intuitively and efficiently search the broadcasting content. Also, the display apparatus 100 according to an exemplary embodiment has an advantage that the whole broadcasting contents can be grasped at one view since it is possible to easily move to a desired content group on the content map according to a user input.

The receiver 110 receives a broadcasting content corresponding to one channel among the plurality of channels. The receiver 110 may be varied depending on signal formats of the received broadcasting content and the types of the display apparatus 100. For example, the receiver 110 may include a tuner that receives a radio frequency (RF) broadcasting signal transmitted from a broadcasting station.

The display 140 displays an image of the broadcasting content received in the receiver 110. The display 140 may include various types of displays, such as a plasma display panel (PDP), a liquid crystal display (LCD), an organic light emitting diode (OLED), a flexible display, etc.

The user input 120 receives a user input. The user input may include a hand gesture control and a touch input with regard to the display 140, a voice command, inputs through a keyboard, a mouse, and a touch pen, etc.

The controller 130 controls the display 140 to display a content map in which the icon of the at least one broadcasting content belonging to a content group is arranged in each corresponding region for the plurality of content groups. The content group may be classified in accordance with at least one of a kind, a genre, a rating of the broadcasting content, a channel and a broadcasting time. For example, as shown in FIG. 2, the controller 130 may classify the plurality of content groups displayed on the content map 210 in accordance with the ‘kind’ of broadcasting content, and display a news region 221, a movie region 222, a drama region 223, and an entertainment region 224.

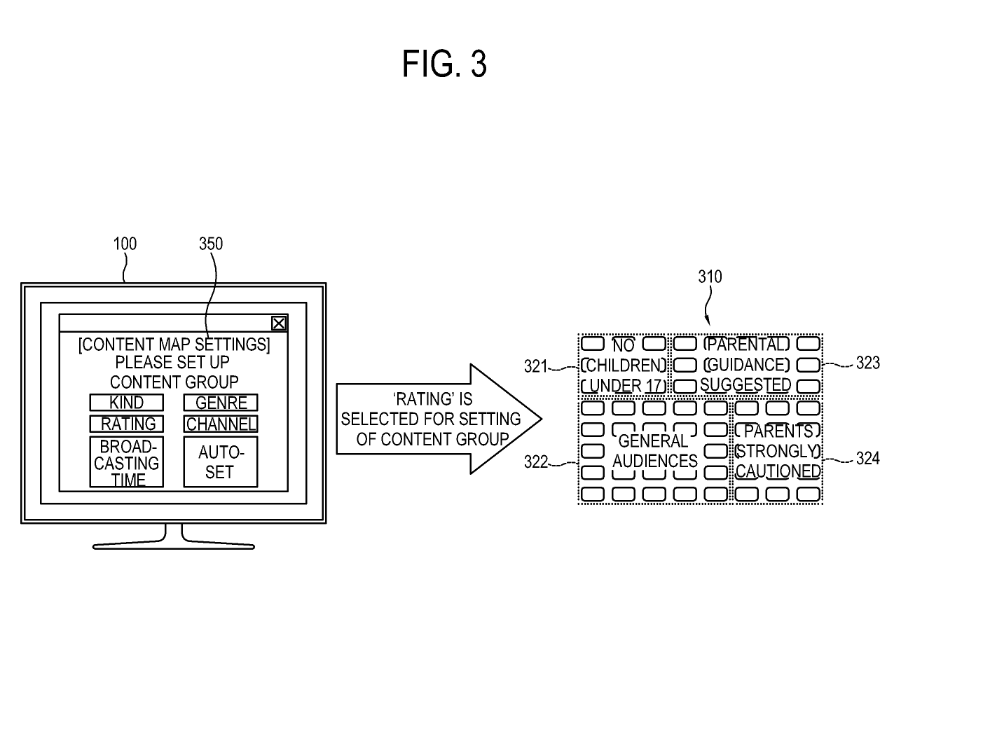

According to an exemplary embodiment, the controller 130 may determine the content group to which the broadcasting content belongs in accordance with a user input. As shown in FIG. 3, a user may select a ‘rating’ among the settings of the content group through a content map setting menu 350 so that a ‘no children under 17’ region 321, a ‘general audiences’ region 322, a ‘parental guidance suggested’ region 323 and a ‘parents strongly cautioned’ region 324 can be displayed on the content map 310. Alternatively, each region for the plurality of content groups may be activated to be selected or inactivated to be not selected in accordance with the settings. For example, if the regions of the content group are displayed in accordance with ratings of the broadcasting content, the ‘no children under 17’ region 321 is inactivated to be not selected, and may be activated to be selected in accordance with a user authentication.

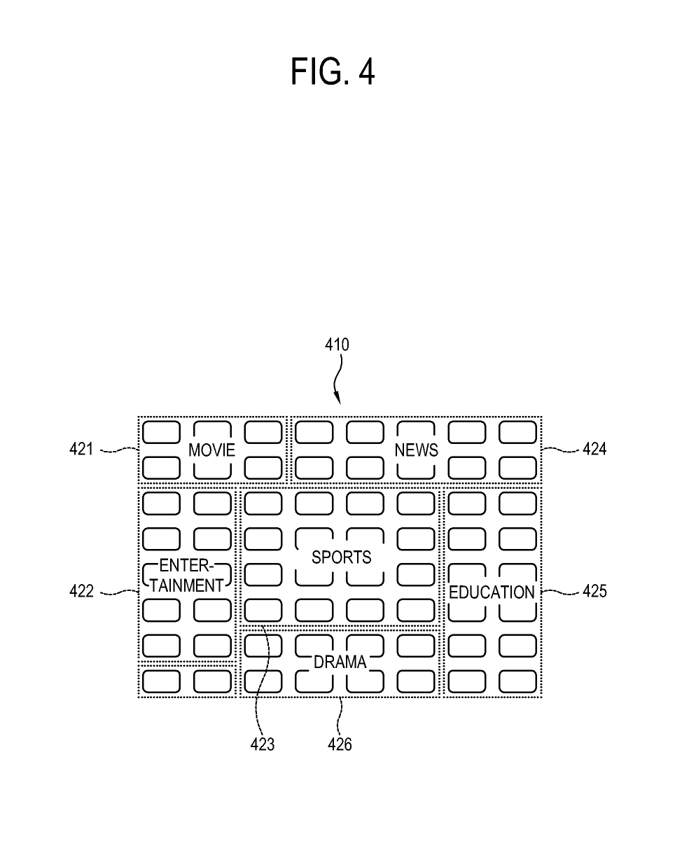

The controller 130 may determine at least one of the position and size of the region for the content group displayed on the content map, based on a user's view history. That is, the controller 130 may determine and display at least one of the position and size of the region for the content group in accordance with a view history such as a user's viewing times, accumulated viewing time, etc. with regard to the broadcasting content belonging to each region of the content group. For example, as shown in FIG. 4, a ‘sports’ region 423 corresponding to a user's high preference may be arranged and displayed to have the largest size at the center of the content map in accordance with the user's view history, and a movie region 421 corresponding to a user's low preference may be arranged and displayed to have a small size at an edge of the content map.

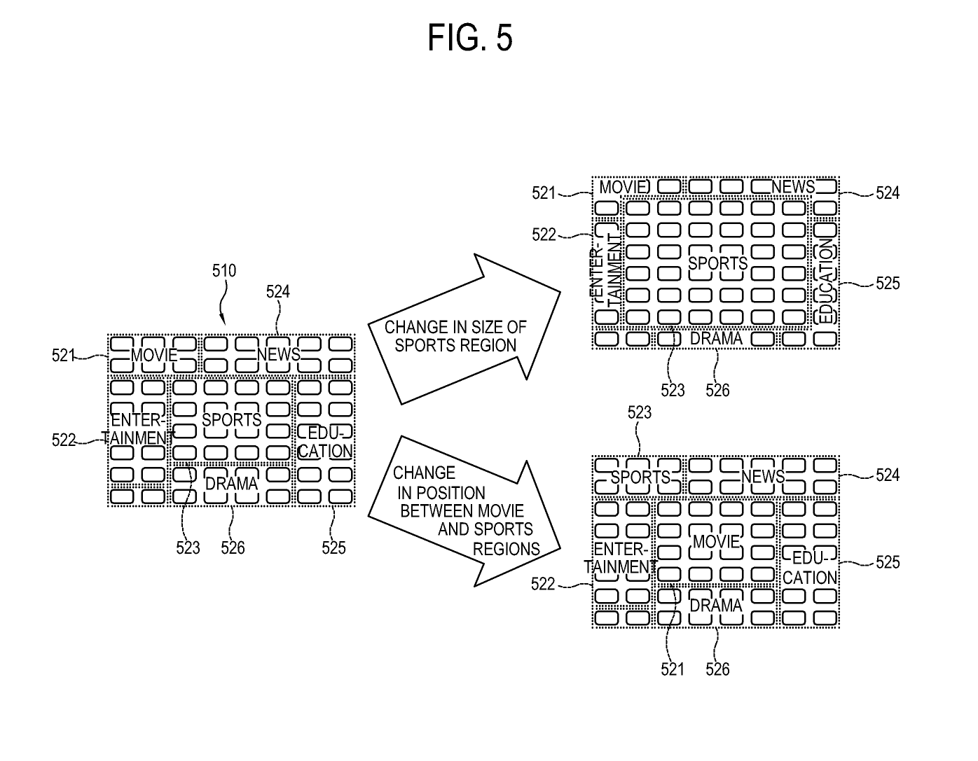

Also, the controller 130 may change at least one of the position and size of the region for the currently displayed content group. For example, as shown in FIG. 5, in response to a user input, the size of the ‘sports’ region 523 may be enlarged among the regions for the currently displayed content groups on a content map, and the position of the ‘movie’ region 521 instead of the ‘sports’ region 523 may be moved to the center.

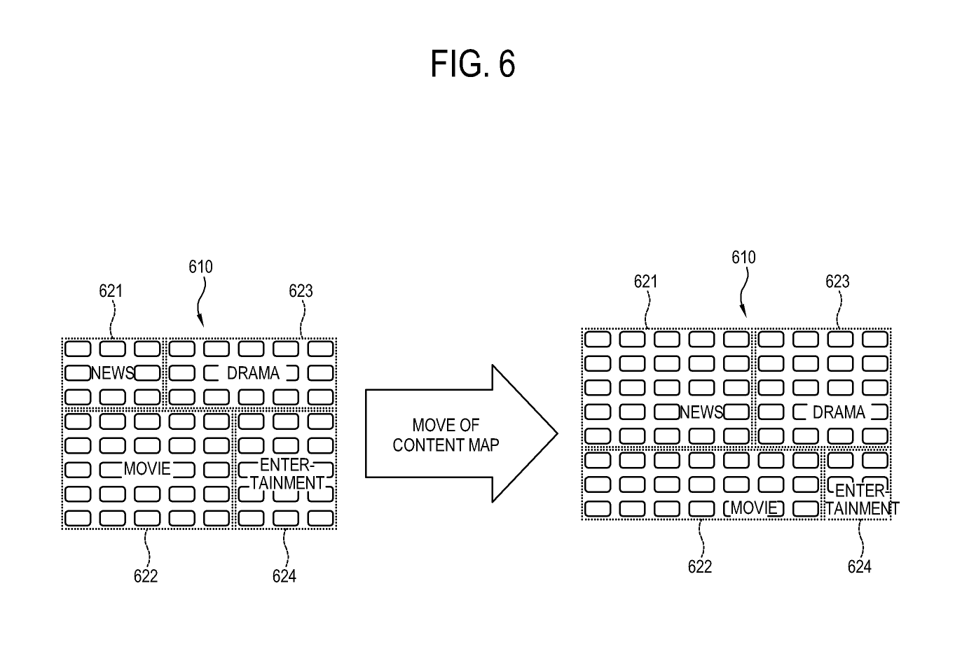

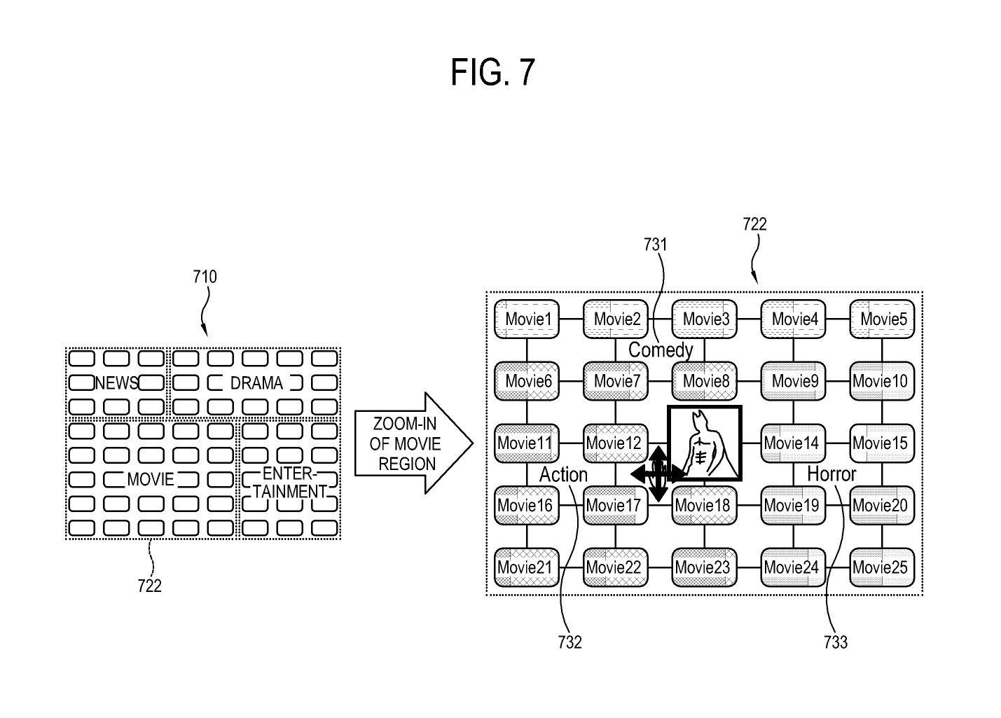

The controller 130 may change the region for the displayed content group by moving the content map according to the user input. The user input may include a hand gesture control with regard to the displayed content map. For example, as shown in FIG. 6, the content map is freely movable by the hand gesture control or the user's input in up, down, left and right directions, so that icons in a ‘news’ region 621 and a ‘drama’ region 623 which are not shown in a screen can be partially displayed. Alternatively, the user input may include input for zooming in or out the region for the content group. As shown in FIG. 7, the ‘movie’ region 722 for the content group displayed on the content map 710 may be zoomed in and displayed as a full screen in response to the hand gesture control, a touch input, etc. The ‘movie’ region 722 displayed on the full screen may be further classified into a ‘comedy’ region 731, an ‘action’ region 732, and a ‘horror’ region 733 in accordance with genre.

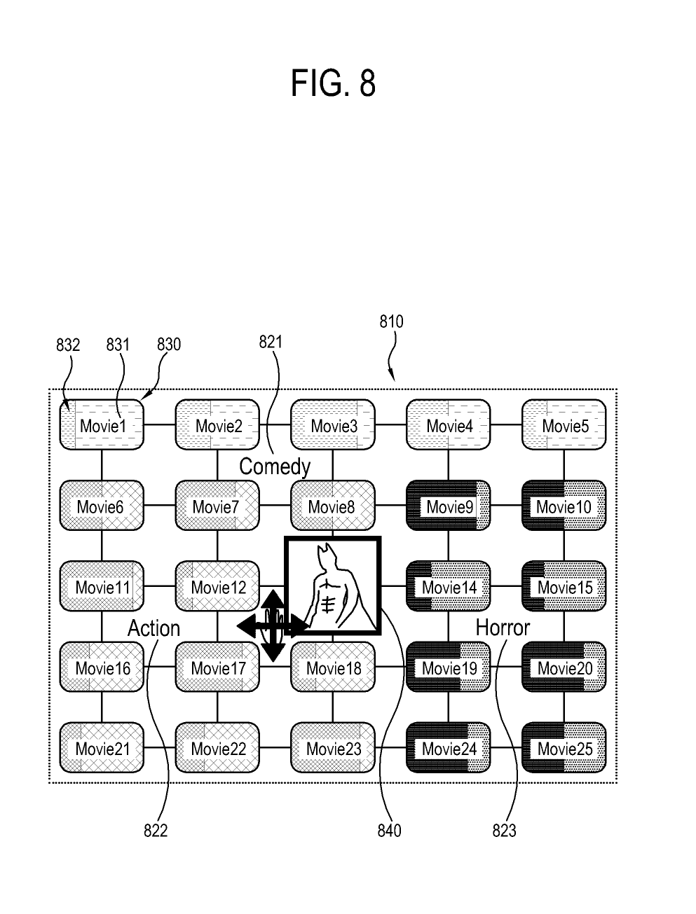

The controller 130 may control an image corresponding to a broadcasting content to be displayed if an icon of the broadcasting content is selected in response to the user input. The controller 130 may control a content view region to be displayed together with the content map, and control a broadcasting content corresponding to the selected icon of the broadcasting content to be displayed within the content view region if the icon of the broadcasting content is selected according to the user input. The user input may include an input of dragging the icon of the broadcasting content to the content view region. Also, the controller 130 may control the broadcasting content displayed within the content view region to be displayed as a full screen according to a user's hand gesture or a voice command. For example, as shown in FIG. 8, when the content view region 840 is displayed at the center of the screen displaying the content map 810, an icon 830 of the desired broadcasting content is selected and dragged into the content view region 840. If a ‘Movie 1’ icon 830 is selected among the icons corresponding to the broadcasting contents and dragged into the content view region 840, an image of ‘Movie 1’ corresponding to the selected icon of the broadcasting content may be reproduced in a form of a preview within the content view region 840, and the reproduced image may be displayed as a full screen in response to the user's hand gesture or voice command.

The user input may include a voice command to select the icon of the broadcasting content. The controller 130 may display a title of the broadcasting content on the icon of the broadcasting content, and store the displayed title of the broadcasting content. As shown in FIG. 8, the title 831 is displayed on the ‘Movie 1’ icon 830, and the displayed title 831 may be automatically stored in a voice recognition database (DB). Thus, when the ‘Movie 1’ is selected by a voice command, it is possible to maximize a voice recognition rate to the corresponding title since the title 831 is stored in the voice recognition DB. In this case, a user can reproduce the image of ‘Movie 1’ on the screen by a voice command without dragging the ‘Movie 1’ icon 830 into the content view region 840.

FIG. 2 shows an example of a content map in which an icon of at least one broadcasting content is arranged in each region of a plurality of content groups according to an exemplary embodiment. As shown in FIG. 2, in order to show all the broadcasting contents being broadcasted on the content map 210, the plurality of content groups are classified in accordance with the ‘kind’ of broadcasting content, thereby displaying the news region 221, the movie region 222, the drama region 223, and the entertainment region 224. The broadcasting contents included in each region of the plurality of content groups are displayed in the form of an icon 230, and the icon 230 of the broadcasting content is displayed to include a text or an image related to the corresponding broadcasting content.

Alternatively, the content map 210 may be configured in units of page, and the content map 210 may show the broadcasting content not being currently broadcasted but to be broadcasted in the future as moved to a different page.

FIG. 3 shows an example of setting up the content group, to which the broadcasting content belongs, in response to a user input according to an exemplary embodiment. As shown in FIG. 3, if a user selects a ‘rating’ among the settings for the content group through the content map setting menu 350, the content groups divided into the ‘no children under 17’ region 321, the ‘general audiences’ region 322, the ‘parental guidance suggested’ region 323 and the ‘parents strongly cautioned’ region 324 are displayed on the content map 310. Thus, the user may manually set up the content groups to be displayed in accordance with the ‘kind’, ‘genre’, ‘rating’, ‘channel’, ‘broadcasting time’, etc. of the broadcasting content through the content map setting menu 350. If the content groups are ‘automatically’ set up, the content group may be displayed in accordance with the previous settings of the content map, or in accordance with preference for the settings of the content map determined based on the user's view history. Meanwhile, each region for the content groups set up in accordance with the user input may be set up to be activated or inactivated with regard to the selection. For example, if the regions of the content groups are displayed in accordance with rating of the broadcasting content, the ‘no children under 17’ region 321 is inactivated to be not selected, but may be activated to be selected in accordance with a user authentication.

FIG. 4 shows an example of determining and displaying at least one of a position and a size of the region for the content group based on a user's view history according to an exemplary embodiment. As shown in FIG. 4, when the regions for the content groups are displayed on the content map 410, the ‘sports’ region 423 corresponding to a user's high preference may be arranged and displayed to have the largest size at the center of the content map 410 in consideration of the user's view history such as the user's viewing times, the accumulated viewing time, etc. with regard to the broadcasting content belonging to each region, and the movie region 421 corresponding to a user's relatively low preference may be arranged and displayed to have a small size at an edge of the content map 410. Thus, at least one of the position and size of the region for the content group is determined and displayed based on the user's view history, and therefore a user can easily search a broadcasting content through a content map formed as desired by the user without any additional setting.

FIG. 5 shows an example of changing at least one of the position and size of the region for the content group displayed on the content map according to an exemplary embodiment. As shown in FIG. 5, in response to a user input, the size of the ‘sports’ region 523 may be enlarged among the regions for the currently displayed content groups on the content map 510, and the position of the ‘movie’ region 521 instead of the ‘sports’ region 523 may be moved to the center. Thus, the user can freely change at least one of the position and size of each region for the content groups on the content map 510 through a hand gesture control, a touch input, etc.

FIG. 6 shows an example of moving the content map so that the region for displaying the content group is changed according to an exemplary embodiment. As shown in FIG. 6, a user freely moves the content map 610 in up, down, left and right directions through the hand gesture control or the like, so that icons in the ‘news’ region 621 and the ‘drama’ region 623 which are not shown on the screen can be partially displayed. Alternatively, the user input may include an input for zooming in or out the region for the content group. Thus, the user can quickly and easily search the region for the desired content group while moving the content map 610 in the up, down, left and right direction.

FIG. 7 shows an example in which the region for the content group selected on the content map is zoomed in and displayed as the full screen. As shown in FIG. 7, the ‘movie’ region 722 for the content group displayed on the content map 710 may be zoomed in to be displayed as the full screen in response to the hand gesture control, the touch input, etc. The ‘movie’ region 722 displayed on the full screen may be further classified into the ‘comedy’ region 731, the ‘action’ region 732, and the ‘horror’ region 733 in accordance with genre. Also, a user may zoom out the ‘movie’ region 722 displayed as the full screen so that the ‘movie’ region 722 can be displayed on the original content map 710.

FIG. 8 shows an example of displaying an image through a content view region displayed together with the content map according to an exemplary embodiment. As shown in FIG. 8, when the content view region 840 is displayed at the center of the screen displaying the content map 810, the ‘Movie 1’ icon 830 is selected among the icons corresponding to the broadcasting contents and dragged into the content view region 840, thereby reproducing an image of ‘Movie 1’ reproduced in the form of a preview within the content view region 840. Alternatively, if the content map 810 is moved so that the ‘Movie 1’ icon 830 can be positioned in the content view region 840 displayed at the center of the screen, the image of “Movie 1” can be automatically reproduced in the content view region 840. Also, the image reproduced in the content view region 840 may be displayed as a full screen by a hand gesture or a voice command.

Alternatively, the image of the broadcasting content corresponding to the icon 830 of the broadcasting content displayed on the content map 810 may be reproduced by a voice command without using the content view region 840. For example, a title 831 of the broadcasting content is displayed on the icon 830 of the broadcasting content displayed on the content map 810, and the displayed title of the broadcasting content is stored in the voice recognition DB, thereby performing the voice command based on the title. That is, when ‘Movie 1’ is selected by a voice command, the image of “Movie 1” is reproduced in response to the voice command without any error of the voice recognition.

All the broadcasting contents displayed on the content map 810 may be updated in real time, and an indicator bar 832 indicating a remaining playback time may be displayed in the icon 830 of the broadcasting content being broadcasted.

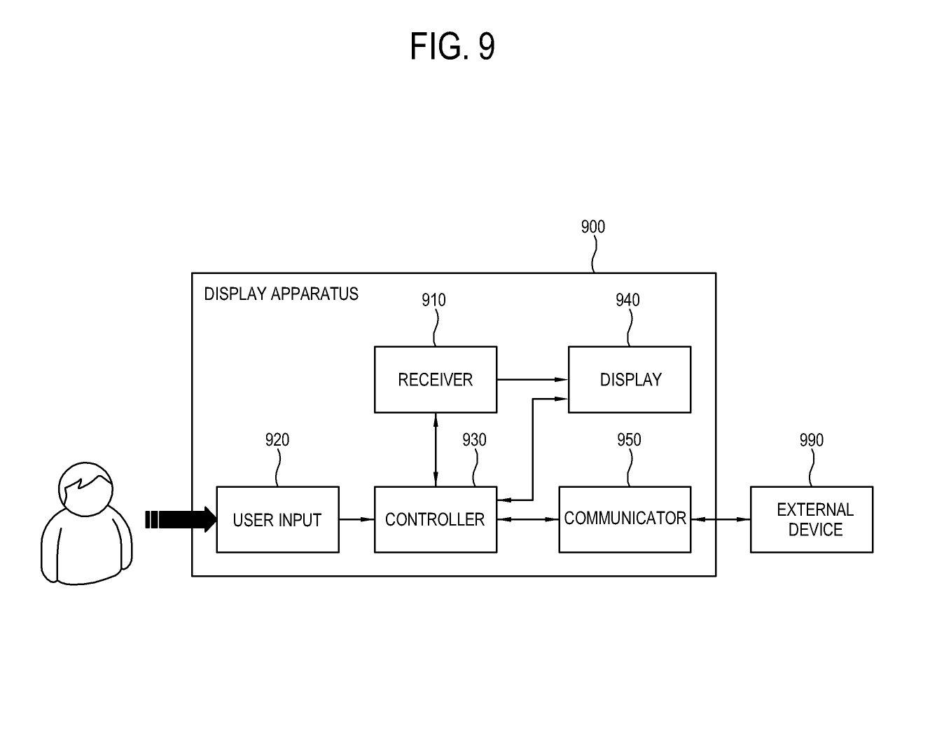

FIG. 9 is a block diagram of the display apparatus connected to an external device according to an exemplary embodiment. Descriptions about similar elements to those of FIGS. 1 to 8 will be omitted. As shown in FIG. 9, a display apparatus 900 includes a receiver 910, a user input 920, a controller 930, a display 940, and a communicator 950, and is connected to an external device 990 through the communicator 950. For example, the display apparatus 900 may include a smart phone, a tablet PC, etc., and the external device 990 may include a smart TV, etc.

The receiver 910 receives a broadcasting content corresponding to one channel among the plurality of channels. The display 940 displays an image of the broadcasting content received in the receiver 910. The user input 920 receives a user input. The user input may include a hand gesture control and a touch input with regard to the display 940, a voice command, inputs through a keyboard, a mouse and a touch pen, etc. The communicator 950 wirelessly communicates with the external device 990.

The controller 930 displays the content map, in which the icon of at least one broadcasting content belonging to the corresponding content group is arranged in each region for the plurality of content groups, on the screen. The controller 930 changes the region of the displayed content group by moving the content map according to the user input, and issues an image reproduction command if the icon of the broadcasting content is selected according to the user input, thereby displaying an image of the broadcasting content corresponding to the selected icon. For example, the display apparatus 900 transmits the image reproduction command to the external device 990 if the icon of the desired broadcasting content is selected on the content map in order to search the desired content, and the external device 990 displays, in response to the transmitted image reproduction command, an image of the broadcasting content corresponding to the selected icon of the broadcasting content. Accordingly, the smart phone or the mobile device can search a desired content through the content map and interwork with the smart TV to reproduce the searched content.

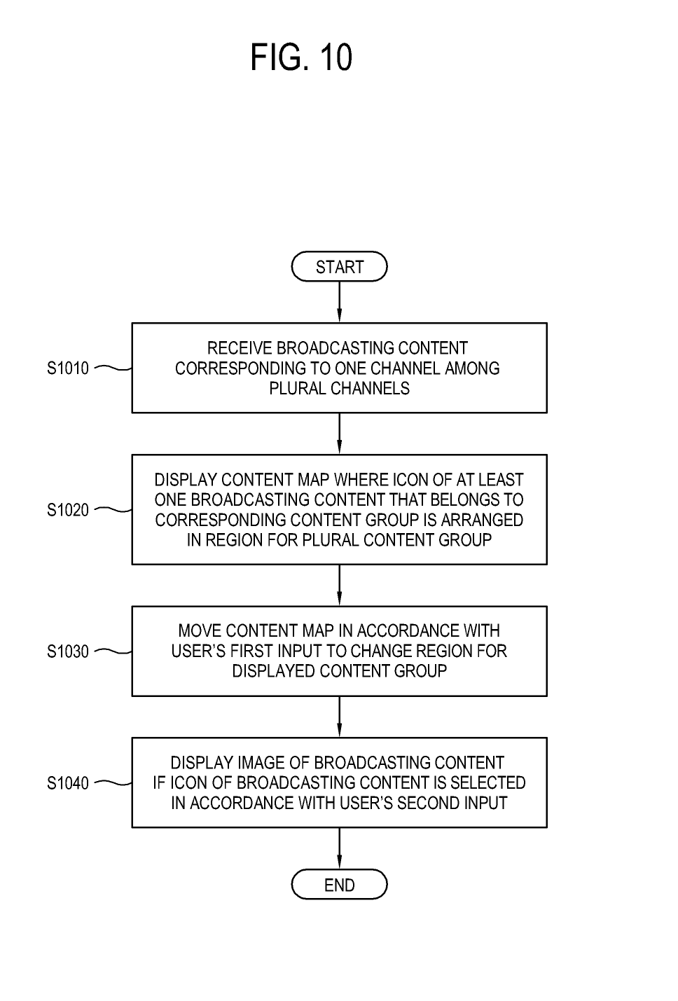

FIG. 10 is a flowchart showing a control method of the display apparatus according to an exemplary embodiment. As shown in FIG. 10, at operation S1010, the broadcasting content corresponding to one channel among the plurality of channels is received. Next, at operation S1020, the display displays the content map in which the icon of at least one broadcasting content belonging to the corresponding content group is arranged in each region for the plurality of content group. The content group may be classified according to at least one of a kind, a genre, a rating, a channel and broadcasting time of the broadcasting content. For example, as shown in FIG. 2, the content group displayed on the content map 210 is classified according to the ‘kind’ of broadcasting content, thereby displaying the news region 221, the movie region 222, the drama region 223, and the entertainment region 224.

Also, an operation may be provided for determining the content group to which the broadcasting content belongs according to a user input. As shown in FIG. 3, a user selects the ‘rating’ among the settings of the content group in the content map setting menu 350, thereby displaying the ‘no children under 17’ region 321, the ‘general audiences’ region 322, the ‘parental guidance suggested’ region 323 and the ‘parents strongly cautioned’ region 324 on the content map 310.

In the control method of the display apparatus according to an embodiment, an operation may be provided for determining at least one of the position and size of the region for the content group displayed on the content map based on a user's view history. Also, an operation may be provided for changing at least one of the position and size of the region for the content group currently being displayed. For example, as shown in FIG. 4, in accordance with the view history such as the user's viewing times, the accumulated viewing time, etc., the ‘sports’ region 423 corresponding to a user's high preference may be arranged and displayed to have the largest size at the center of the content map, and the ‘movie’ region 421 corresponding to a user's low preference may be arranged and displayed to have a small size at an edge of the content map. Also, as shown in FIG. 5, the size of the ‘sports’ region 523 among the regions for the content groups currently displayed on the content map 510 may be changed, or the positions of the ‘sports’ region 523 and the ‘movie’ region 521 may be changed.

Next, at operation S1030, the region for the displayed content group is changed by moving the content map according to the user input. The user input may include the hand gesture control with regard to the displayed content map. For example, as shown in FIG. 6, the content map is freely moved in up, down, left and right directions by the hand gesture control or the like user input, so that the regions for the unseen content group can be displayed. Also, as shown in FIG. 7, the ‘movie’ region 722 of the content group displayed on the content map 710 may be zoomed in and displayed as the full screen.

At operation S1040, if the icon of the broadcasting content is selected according to the user input, the image of the broadcasting content corresponding to the selected icon of the broadcasting content is displayed. According to an exemplary embodiment, there are provided an operation of displaying the content view region together with the content map, and an operation of displaying the broadcasting content corresponding to the selected icon of the broadcasting content in the content view region if the icon of the broadcasting content is selected by the user input. The user input may include an input for dragging the icon of the broadcasting content into the content view region. Also, an operation may be provided for displaying the broadcasting content displayed in the content view region as a full screen according to a user's hand gesture or voice commands.

The user input may include a voice command to select the icon of the broadcasting content. An operation is provided for displaying the title of the broadcasting content on the icon of the broadcasting content, and storing the displayed title of the broadcasting content. For example, as shown in FIG. 8, the title 831 is displayed on the “Movie 1” icon 830, and the displayed title 831 is automatically stored in the voice recognition DB. Thus, if “Movie 1” is selected by a voice command, the voice command is correctly recognized without any error based on the title 831 stored in the voice recognition DB, thereby reproducing the image of the corresponding broadcasting content.

As described above, there is provided a display apparatus that displays the content map in which the icon of at least one broadcasting content is arranged in each region for the plurality of content groups, and displays an image of the broadcasting content if the icon of the broadcasting content is selected by moving the content map according to a user input, thereby allowing the user to more intuitively and efficiently search the broadcasting content.

Also, it is easy to move a desired content group on the content map according to a user input, thereby having an effect on grasping the whole broadcasting contents at one view.

While the above-described exemplary embodiments relate to a display apparatus, it is understood that other exemplary embodiments are not limited thereto. For example, one or more other exemplary embodiments may relate to an image processing apparatus such as a set-top box, a stand-alone control device, an audio/video receiver, an optical media player, an image source, etc.

While not restricted thereto, an exemplary embodiment can be embodied as computer-readable code on a non-transitory computer-readable recording medium. The non-transitory computer-readable recording medium is any data storage device that can store data that can be thereafter read by a computer system. Examples of the non-transitory computer-readable recording medium may include read-only memory (ROM), random-access memory (RAM), CD-ROMs, magnetic tapes, floppy disks, and optical data storage devices. The non-transitory computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, one or more components or elements of the above-described apparatuses may include a processor or microprocessor executing a computer program stored in a computer-readable medium.

Although a few exemplary embodiments have been shown and described, it will be appreciated by those skilled in the art that changes may be made in the exemplary embodiments without departing from the principles and spirit of the inventive concept, the scope of which is defined in the appended claims and their equivalents.

What is claimed is:

1. A display apparatus comprising:
a receiver configured to receive a broadcasting content corresponding to one channel among a plurality of channels;
a display configured to display an image of the received broadcasting content;
a user input configured to receive a user input; and
a controller configured to control the display to display a content map in which an icon of at least one broadcasting content belonging to a corresponding content group is arranged in a region for a plurality of content groups, and display an image of the broadcasting content in response to the icon of the broadcasting content being selected according to the user input.

2. The display apparatus according to claim 1, wherein the controller is configured to change the region for the displayed content group by moving the content map according to the user input move, in response to the user input.

3. The display apparatus according to claim 1, wherein the content group is classified according to at least one of a kind, a genre, a rating, a channel, and broadcasting time of the broadcasting content.

4. The display apparatus according to claim 1, wherein the controller is configured to determine the content group to which the broadcasting content belongs according to the user input.

5. The display apparatus according to claim 1, wherein the controller is configured to determine at least one of a position and a size of the region for the content group displayed on the content map based on a user's view history.

6. The display apparatus according to claim 1, wherein the controller is configured to change at least one of a position and a size of the region for the content group currently being displayed.

7. The display apparatus according to claim 2, wherein the user input comprises a hand gesture control with regard to the displayed content map.

8. The display apparatus according to claim 1, wherein the controller is configured to control a content view region to be displayed together with the content map, and control a broadcasting content corresponding to a selected icon of a broadcasting content to be displayed in the content view region in response to the icon of the broadcasting content being selected according to the user input.

9. The display apparatus according to claim 8, wherein the user input comprises an input of dragging the icon of the broadcasting content into the content view region.

10. The display apparatus according to claim 8, wherein the controller is configured to control the broadcasting content displayed in the content view region to be displayed as a full screen according to a user's hand gesture or a voice command.

11. The display apparatus according to claim 1, wherein the user input comprises a voice command to select the icon of the broadcasting content.

12. The display apparatus according to claim 11, wherein the controller is configured to display a title of the broadcasting content in the icon of the broadcasting content, and to store the displayed title of the broadcasting content.

13. A control method of a display apparatus, the method comprising:
receiving a broadcasting content corresponding to one channel among a plurality of channels;
displaying a content map in which an icon of at least one broadcasting content belonging to a corresponding content group is arranged in a region for a plurality of content group; and
displaying an image of the broadcasting content if the icon of the broadcasting content is selected according to a user input.

14. The method according to claim 13, further comprising changing the region for the displayed content group by moving the content map according to the user input.

15. The method according to claim 13, wherein the content group is classified according to at least one of a kind, a genre, a rating, a channel, and broadcasting time of the broadcasting content.

16. The method according to claim 13, further comprising determining the content group to which the broadcasting content belongs according to the user input.

17. The method according to claim 13, further comprising determining at least one of a position and a size of the region for the content group displayed on the content map based on a user's view history.

18. The method according to claim 13, further comprising changing at least one of a position and a size of the region for the content group currently being displayed.

19. The method according to claim 14, wherein the user input comprises a hand gesture control with regard to the displayed content map.

20. The method according to claim 13, further comprising:
displaying a content view region together with the content map; and
displaying a broadcasting content corresponding to a selected icon of a broadcasting content in the content view region in response to the icon of the broadcasting content being selected according to the user input.

21. The method according to claim 20, wherein the user input comprises an input of dragging the icon of the broadcasting content into the content view region.

22. The method according to claim 20, further comprising displaying the broadcasting content displayed in the content view region as a full screen according to a user's hand gesture or a voice command.

23. The method according to claim 13, wherein the user input comprises a voice command to select the icon of the broadcasting content.

24. The method according to claim 23, further comprising:
displaying a title of the broadcasting content in the icon of the broadcasting content; and
storing the displayed title of the broadcasting content.

25. A control method of an image processing apparatus, the method comprising:
controlling to display a content map in which an icon of at least one broadcasting content belonging to a corresponding content group is arranged in a region for a plurality of content group; and
controlling to change the region for the plurality of content group by moving the content map according to the user input, and to display an image of the broadcasting content in response to the icon of the broadcasting content being selected according to the user input.

26. The method according to claim 25, wherein the controlling to display the image of the broadcasting content comprises controlling to display the broadcasting content corresponding to the selected icon of the broadcasting content in a content view region being displayed together with the content map.

27. The method according to claim 25, wherein the user input comprises at least one of a hand gesture, a touch input, and a voice command.

28. The method according to claim 26, the controlling to display the broadcasting content corresponding to the selected icon of the broadcasting content in a content view region comprises controlling to display the broadcasting content displayed in the content view region as a full screen according to the user input.

29. A non-transitory computer readable recording medium having recorded thereon a program executable by a computer for performing the method of claim 13.

30. A non-transitory computer readable recording medium having recorded thereon a program executable by a computer for performing the method of claim 25.
